(19) United States
(12) Patent Application Publication
(10) Pub. No.: US 2013/0006788 A1
(43) Pub. Date: Jan. 3, 2013

(54) RETAIL ENVIRONMENTS WITHIN SOCIAL NETWORKING ENGINES

(76) Inventors: Tiger T G Zhou, Tiburon, CA (US); Dylan T X Zhou, San Gabriel, CA (US); Andrew H B Zhou, Tiburon, CA (US)

(21) Appl. No.: 13/471,773

(22) Filed: May 15, 2012

Related U.S. Application Data
(63) Continuation-in-part of application No. 13/172,892, filed on Jun. 30, 2011.

(51) Int. Cl. G06Q 30/06; G06F 15/16

(52) U.S. Cl. 705/26.1

(57) ABSTRACT

Provided are novel methods and systems for integrating various aspects of online retailing and social networks to provide more effective and efficient online shopping experience. Social networks are designed to gather and manage information about their users and users' environments and may include features such as ranking users' connections, interests, activities, and even credibility. This social networking information may be leveraged to provide tailored product information to the users. As such, social networks also serve as marketing tools that are at least in part driven by the users. Users are expected to pay more attention and to trust product information and product offerings that came from their own social groups as opposed to traditional marketing channels, such as online ads.

### CROSS-REFERENCE TO RELATED APPLICATIONS

This application is a continuation-in-part of U.S. patent application Ser. No. 13/172,892, entitled “RETAIL ENVIRONMENTS WITHIN SOCIAL NETWORKING ENGINES,” filed on Jun. 30, 2011, which is incorporated herein by reference in its entirety.

### FIELD

This application relates generally to data processing, and more specifically to systems and methods for selling product via social networking engines.

### BACKGROUND

Development of Internet technologies resulted in proliferation of social networking, online retailing, and many other helpful tools. Recently, Facebook reported having more than 500 million users (i.e., almost 10% of the entire world population), and its user base continues to grow. The Internet changed the way people communicate, find and share information, learn, build and maintain their relationships, sell and purchase goods and services, and perform many other everyday activities. Internet companies try to develop tools that emulate the way people interact with each other in real life. However, many of these tools are developed for specific purposes, such as social networking or retailing. Rarely, some tools may be more encompassing than other but people are still forced to constantly navigate and jump from one website to another, often blindly and in ad hoc manner. This deteriorates the overall Internet experience and often requires people to have multiple logins. Furthermore, people often have to manually aggregate various bits and pieces of information on their own back ends before making a simple decision, such as purchasing an item from an online retailer. For example, one website may provide product information, while another may provide product reviews, yet even more websites may be involved to rank online retailers, to process payments, to solicit feedback, and to deal with customer complaints. Proliferation of websites, players, and services, which are often faceless entities with short life span undermines their reputations and make online product purchasing decision more difficult. Also, websites are often used for malicious purposes, such as to steal identity or payment.

As mentioned above, many e-commerce players operate in separate and independent clusters that do not allow users to operate in a seamless manner when performing various tasks. Furthermore, these clusters do not provide much information sharing and users have to jump between various websites to gather a comprehensive collection of information. Take, for example, product review services. Websites providing such services operate as standalone databases and contain somewhat questionable information usually provided by disingenuous producers and their competitors and a few outraged real customers. Average consumers usually have very little incentives to spend their time providing information to an unknown mass of future website visitors. Social networking provides different dynamics among its users. Unlike interacting with relatively unknown information providers and recipients, users of social networks have somewhat defined relationships with other users. As such, information shared within the social network environment tends to be more reliable and trustworthy, and content or goods offered by other users of social networks attract more attention. Furthermore, users may have more incentives to share their experiences (whether related to a bad day in school or a defective product) with their known contacts.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are novel methods and systems for integrating various aspects of online retailing and social networks to provide more effective e-commerce experience. The technology is novel and other social network operators such as Facebook, Twitter, and LinkedIn do not currently employ such technology. Social networks are designed to gather and manage information about their users and users' environments. Networks may include features such as ranking users' connections, interests, activities, and even credibility. Such information may be leveraged to provide more tailored product information to the network users. Therefore, social networks may also serve as powerful marketing tools that are in part driven by their own users. Users will likely pay more attention and trust information provided by their own contacts than from traditional marketing channels, such as online ads. Furthermore, social networking providers may use this additional functionality to generate revenues. Specifically, a network may collect a partial payment from its users when the users make purchases based on information provided by the network.

In certain embodiments, a method for selling a product via a social networking engine involves receiving information associated with the product to be sold from a selling user. The selling user may then issue a request to publish a message associated with the product via one or more social networking engines. The message may be published in a social network page associated with the selling user.

In certain embodiments, a method also involves receiving from a user, via a user interface of the social networking engine, product selection information and redirecting the user to a purchasing interface for purchasing one or more product items based on the product selection information. The purchasing interface may be provided by the system or by the social networking engine. The method may also involve receiving a credit from a selling user for a sale of the product of this selling user. In certain embodiments, a method involves receiving from a user a payment information (e.g., at the purchasing interface) and, after receiving the payment information, receiving a credit for the selling user. Furthermore, after receiving the payment information, the method may involve prompting the user to provide feedback information. This feedback information may be used in later operations for ranking products and tailoring offerings to the user preferences. In certain embodiments, payment information is automatically retrieved based on identification information of the user in a social network.

Also provided is a system for selling a product via a social networking engine. The system may include a communication module to receive, from a selling user, information associated with the product, a request to publish a message associated with the product via social networking engines, a request, from a user of a social networking service, to purchase the product, a publishing module to publish the message associated with the product via social networking engines, and a storing module to store the information associated with the product.

In certain embodiments, the system may also include a payment module configured to receiving payments from users for product purchasing, and receiving a credit for the product purchase for a selling user and a credit for each sale of the product.

Provided also a computer-readable medium including instructions, which when executed by one or more processors, perform the following operations: receive, from a selling user, information associated with the product; receive, from the selling user, a request to publish a message associated with the product via social networking engines; and publish the message associated with the product via social networking engines.

In further exemplary embodiments, modules, subsystems, or devices can be adapted to perform the recited steps. Other features and exemplary embodiments are described below.

### BRIEF DESCRIPTION OF DRAWINGS

Embodiments are illustrated by way of example and not limitation in the figures of the accompanying drawings, in which like references indicate similar elements and in which:

FIG. 1 is a block diagram showing architecture for operating systems and methods for selling products via a social networking engine, in accordance with certain embodiments.

FIG. 2 is a block diagram showing various modules of the system for selling a product via a social networking engine, in accordance with certain embodiments.

FIG. 3 is a flow chart illustrating a method for selling a product via a social networking engine, in accordance with certain embodiments.

FIG. 4 is a schematic diagram illustrating an example of a computer system for performing any one or more of the methods discussed herein.

### DETAILED DESCRIPTION

Systems and methods described herein may allow a social network engine operator to provide e-commerce functionality within various services, such as social networking website, a microblog, a webmail, a blog, mobile short message, and a business directory. The business directory may be local and include restaurants, shops, and hotels.

A social network engine may include or be coupled to a system for selling a product via a social networking engine. The system for selling a product via a social networking engine may allow users to offer their products in the form of content, such as text, video, computer code, or combination thereof, or physical articles for sale within various services, such as a social networking website, a microblog, a webmail, a blog, mobile short message, and a business directory. In case of products in the form of content, it may be uploaded by the selling user to the system for selling a product via a social networking engine with some descriptive information, and then the selling user may request to publish a message associated with the product offered for sale. In some example embodiments, the message may be published in a personal page of the selling user in a social networking website, a microblog, or in a webmail, a blog, mobile short message. Other users may be able to view the message and select the product described in the message. After selecting the product they may be redirected to a purchasing or payment system.

The system for selling a product via a social networking engine may facilitate purchases and receive payments by providing a proprietary or a third party payment system (e.g., PayPal). Upon finalizing of the transaction, the system for selling a product via a social networking engine may transfer funds or send a coded voucher to the selling user. Prior to transferring the funds to the selling user, the system may withhold predetermined commissions. This approach may allow the operators of social network engines coupled to the system or including the system to receive prepaid commissions, while selling users can sell their goods and services without having to spend funds on promotion. This may be very beneficial to selling users who do not have sufficient funds to promote their goods and services on the Internet.

In another example embodiment, the system may provide links to the categorized listings within other websites. Users selecting such links may be directed to the third party website where they will be able to purchase goods and/or services associated with the respective links. Additionally, while using the service provided by the social network engine, the users may be allowed to continue shopping within the same or other categories of goods and services. Alternatively, instead of transferring the users to the website operated by the social network engine, a code snippet may be embedded elsewhere so that user can buy goods and services without leaving other websites. This embedded functionality may allow users to log in and complete transactions without being transferred to the website operated by the social network engine. The system may also provide embedded payment functionality or a proprietary payment system (e.g., PayPal) to pay for the goods and services. Upon completion of a transaction, the social network engine may transfer funds to the selling user or send the selling user a coded voucher. Prior to transferring the funds, the third party may withhold its commissions.

Various systems and methods for selling a product via a social networking engine are described. Leveraging social contacts and information available from social networks to distribute product offerings in a fast and efficient manner provides new marketing opportunities not previously possible or available. Specifically, social networks contain much information about their users and users' environments. This information may be used for tailoring various product offering and improving the overall e-commerce experience. For example, social networks may include features for ranking users' connections, interests, activities, and even credibility. Furthermore, users are much more likely to pay more attention and trust information provided by their own contacts than from traditional marketing channels, such as online ads. Likewise, users are more likely to share information when it is directed to a known group of people rather than a faceless mass of general internet users. These marketing tools provide new revenue generating opportunities for social networking providers. For example, a network may collect a partial payment from its users or selling users when the users make purchases based on information provided by the network or when a product of the selling user is purchased.

For purposes of this document, a social networking engine is defined as any online tool that allows users to establish connections and “online relationships” and share information in a restricted manner defined by these connections and relationships. For example, a user may define a group of other trusted users, ignore other users, and/or set thresholds for users to join groups and other communication channels. Some existing examples of social network engines include Facebook, Friendster, Twitter, and other similar services. However, one having ordinary skills in the art would understand that social networking engines are not limited to these examples. Social network engines may be standalone systems or built as add-ons to some existing online retail environments, such as E-bay, Amazon, and Alibaba. Other examples of social networking engines include micro-blogging websites and online media sources.

In specific embodiments further described below, social networking engines are configured to receive prepaid commissions from either their users (when users pays for services or products or from user's prepaid accounts) or from selling users when users buy products offered by the selling users based on information provided via the social networking engines. A user may establish a prepaid account (e.g., a credit and/or debit account) with a social networking engine and use this account for making payments to different merchants. This account may be also used for sharing funds with other users, e.g., loaning money and so forth. Overall, social network users may benefit in various ways from being able to prepay for products and services.

In certain embodiments, a social networking website provides product information and then redirects its users to specialized websites for completing additional transactions. In other embodiments, a social networking website includes built-in e-commerce functionalities allowing its users to shop and purchase goods and services without leaving the network or, more specifically, without leaving a website associated with the network. A network may list some selling users according to predefined categories, e.g., categories organized according to the product or service provided. Selling users may be local businesses targeting users based on their geographic location. For example, real estate brokers operating in a particular geographical locale may be linked to the uses in the same locale or users interested in linking into this locale. Selling users may be added to social networking engine databases by network operators (e.g., in exchange for a membership fee) or by users (e.g., based on previous experiences). Some limitations may be placed on user-added listings to prevent too many selling user listings and control information. For example, a power user level may be defined with specific thresholds for this purpose.

In certain embodiments, a social networking engine may allow users to provide recommendations, write reviews, comments, rank selling users, and send their information to their social network connections. Based on the recommendations and other reputation data, a user may be promoted or demoted within its listed category.

A social networking engine may facilitate purchases and receive payments by providing a proprietary or third party payment system (e.g., PayPal). Thereafter, the third party may transfer funds or send the appropriate merchant a coded voucher. When the funds are transferred to the selling user, the networking engine may withhold its commissions. This approach allows the engine to receive prepaid commissions. Additionally, selling users may sell goods and services without having to spend funds on promotion of their goods and services. This may be very beneficial, for example, to users that may not have funds to advertising of their products or services.

In certain embodiments, a social networking engine inserts links to their categorized listings within other websites. A user selecting such a link is then directed to the system website for purchasing goods or services associated with the link. Additionally, the user may be allowed to continue shopping within the same or other categories of goods and services on the social network website or other external websites.

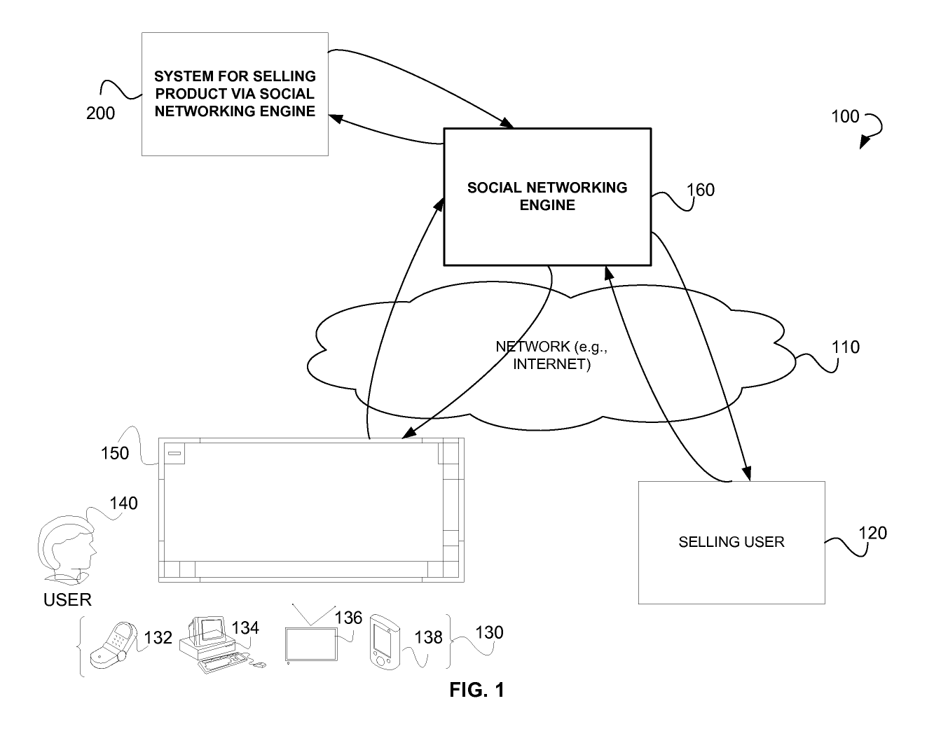

FIG. 1 shows an architecture 100 within which systems and methods for and selling a product via a social networking engine 160 can be implemented. The architecture 100 may include a network 110, a selling user 120, client devices 130, a user 140, a user interface 150, a social networking engine 160, and a system for selling a product via a social networking engine 200. The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 120 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 may be a network of data processing nodes that are interconnected for the purpose of data communication.

The selling user 120 may represent a seller who is selling goods or services online in real-time, without an intermediary service, over the Internet. To facilitate commercial transaction, the selling user 120 may have an online store. Online selling users may offer various products and services for sale. The selling user 120 may provide its own website for completing a transaction. The social networking engine 160 may direct its users to this website based on various information and operations performed by the social networking engine 160. Alternatively or in addition to the above example, the selling user may supply various product information to the social networking engine 160 and most or all purchasing operations are performed by the social networking engine 160 or the system for selling a product via a social networking engine 200.

The client devices 130, in some example embodiments, may include a Graphical User Interface (GUI) for displaying the user interface 150. In a typical GUI, instead of offering only text menus or requiring typed commands, the system presents graphical icons, visual indicators, or special graphical elements called widgets that may be utilized to allow the user 140 to interact with the user interface 150. The client devices 130 may be configured to utilize icons used in conjunction with text, labels, or text navigation to fully represent the information and actions available to users.

The client devices 130 may include a mobile telephone 132, a computer 134, a television (TV) set 136, and a personal digital assistant (PDA) 138. The user 140, in some example embodiments, is a person interacting with the user interface 150 via the client devices 130. The user 140 is a member of a social network provided by the social networking engine 160. The user 140 may periodically interact with the social networking engine 160 and provide various information to the social networking engine 160. This information is stored and, in certain embodiments, analyzed by the social networking engine 160 or system for selling product via social networking engine 200 to create user specific information, such as user's profile. This information may include various demographic information about the user 140 (e.g., age, gender, location), user's interests and preferences (e.g., colors, price ranges, previous transactions), user's connections in the social network (e.g., friends) and other types of information.

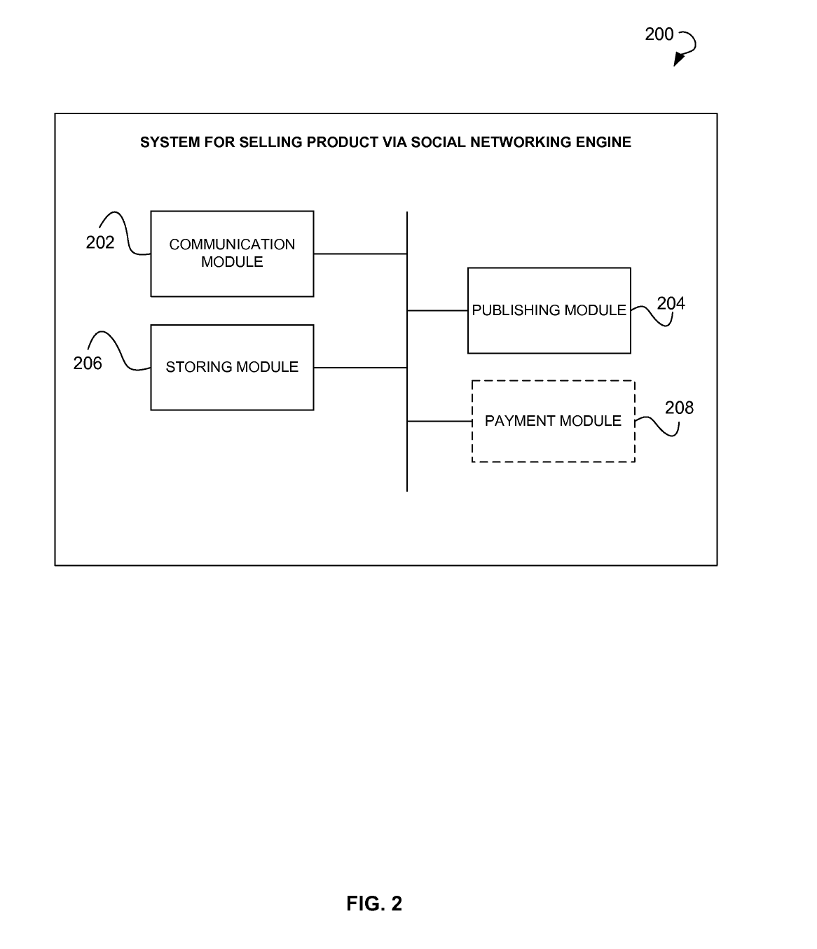

FIG. 2 illustrates a block diagram showing various modules of the system for selling a product in a social networking engine, in accordance with certain embodiments. The system for selling product in social networking engine 200 may include a communication module 202, a publishing module 204, a storing module 206, and a payment module 208 (optional).

Note that even though the system for selling product via social networking engine 200 is shown separately from the social networking engine 160, it may be included in the social networking engine 160.

The communication module 202 of the system for selling product via social networking engine 200 may be configured to receive, from a selling user, information associated with the product, and a request to publish a message associated with the product in social networking services. The communication module 202 may be also used for receiving requests, from users of social networking services, to select the product. In certain embodiment, the communication module 202 is also used for interacting with third party payment processors, such as VISA or American Express payment switches.

The publishing module 204 may be configured to publish the messages associated with the products received from selling users in various services. For example, messages may be published in social networking web sites in personal pages of the selling users in social networks. A message may include descriptive information about the product offered for sale, a preview image, text, audio, video, and so forth, and a link to a purchasing interface.

The storing module 206 may be used to store product information provided by a selling user. In some cases, when the product is in the form of content, the storing module 206 may be used to store the content itself. Then the content may be provided for downloading to a user, who purchased it.

The payment module 208 (optional) may be configured to process a payment transaction associated with a purchase of the product selected by the user. The payment functionality may include various means of payment, which facilitate acceptance of electronic payments for online transactions. E-commerce payment systems have become increasingly popular due to the widespread use of the internet-based shopping and banking. There are numerous payments systems available for online merchants. These include the traditional credit, debit, and charge card, but also new technologies, such as digital wallets, e-cash, mobile payment, and e-checks. Another form of the payment system is allowing a 3rd party to complete the online transaction for you, which are often referred to as Payment Service Providers (PSP). In certain embodiments, the social networking engine may store credit and/or debit information associated with users' of the social network.

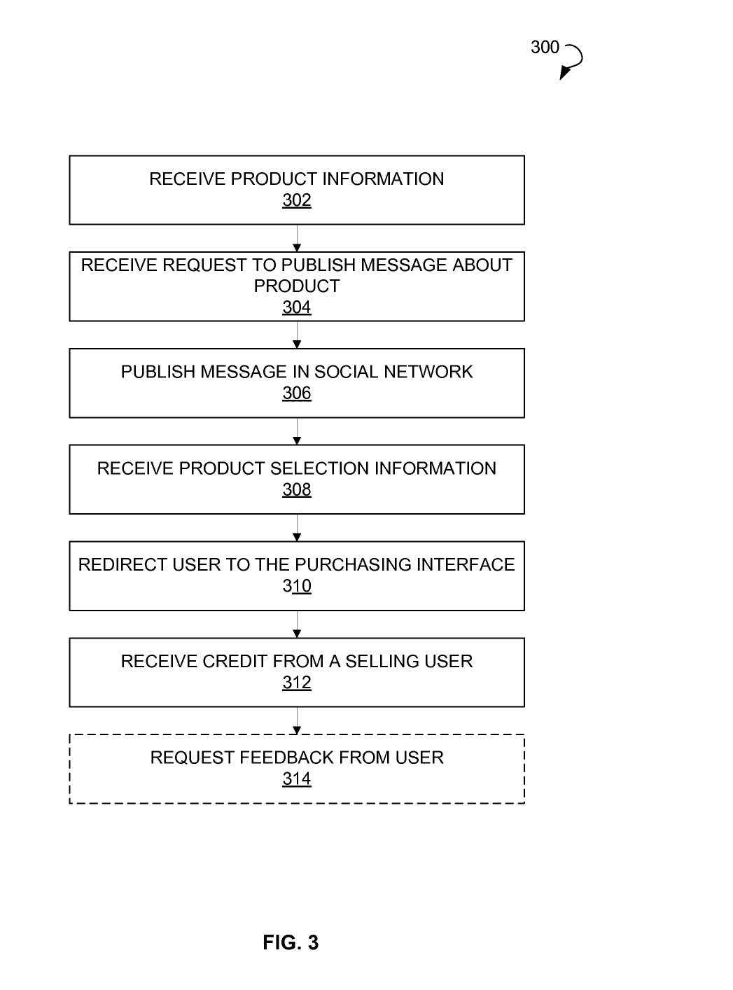

FIG. 3 shows a flow chart 300 illustrating a method for selling a product via a social networking engine, in accordance with an example embodiment. The method 300 may be performed by processing logic that may comprise hardware (e.g., dedicated logic, programmable logic, microcode, etc.), software (such as computer code executable on a general-purpose computer system or a specifically configured computer system), or a combination of both. In one example embodiment, the processing logic resides at the system for selling product via social networking engine 200, illustrated in FIG. 2. The method 300 may be performed by the various modules discussed above with reference to FIG. 2. Each of these modules may comprise processing logic.

As shown in FIG. 3, the method 300 may commence at operation 302, with the communication module 202 receiving, from a selling user, product information. This information may include descriptive information about the product offered for sale, a preview image, text, audio, video, and so forth, and, in case of a product being content, the product itself.

At operation 304, the system for selling a product via a social networking service 200 receives a request to publish a message about the product offered for sale from the selling user. The product information may be included in the message. Based on the selling user input, the message may be published in various services, such as social networking website, a microblog, a webmail, a blog, mobile short message, and a business directory. At operation 306, the publishing module 204 may publish the message based on the input of the selling user.

The users of the service where the message was published may view it and select the product. For example, a user may click on one of the hyperlinks in the message provided during operation 306. When this happens, the product selection information may be received by the communication module 202 at operation 308. After that, the user, who selected the product, may be redirected to the purchasing interface at operation 310. The purchasing interface may be a part of the social networking engine or a part of a separate engine or website. In certain embodiments, a new browser window or a portion of the existing window is used to display this external information to avoid switching back and forth.

At certain point, a user may complete transaction and purchase the product. As stated above, this transaction may be completed through the social networking engine or through some external website or engine. At this point, the social networking engine may receive credit from the selling user in operation 312. A credit may be also issued for other serviced provided by the social networking engine even though these services may not have necessarily resulted in a sale.

A credit may be received from the selling user in a separate transaction or subtracted from a payment received from the user. In this later example, a social networking engine acts as a seller and a payment collector and then distributes this payment according to certain predetermined rules. One having ordinary skills in the art would understand that additional parties, such as payment processing services, may be involved in this operation as well, and used credit to the social networking engine. Therefore, the credit does not need to come always directly from the selling user in operation 312.

Process 300 may also involve requesting feedback from a user in operation 314. This feedback may be later used for ranking products and merchants, identifying user's interests and preferences and sharing these interests and preferences with other users (e.g., established contacts with the social networking), and other uses.

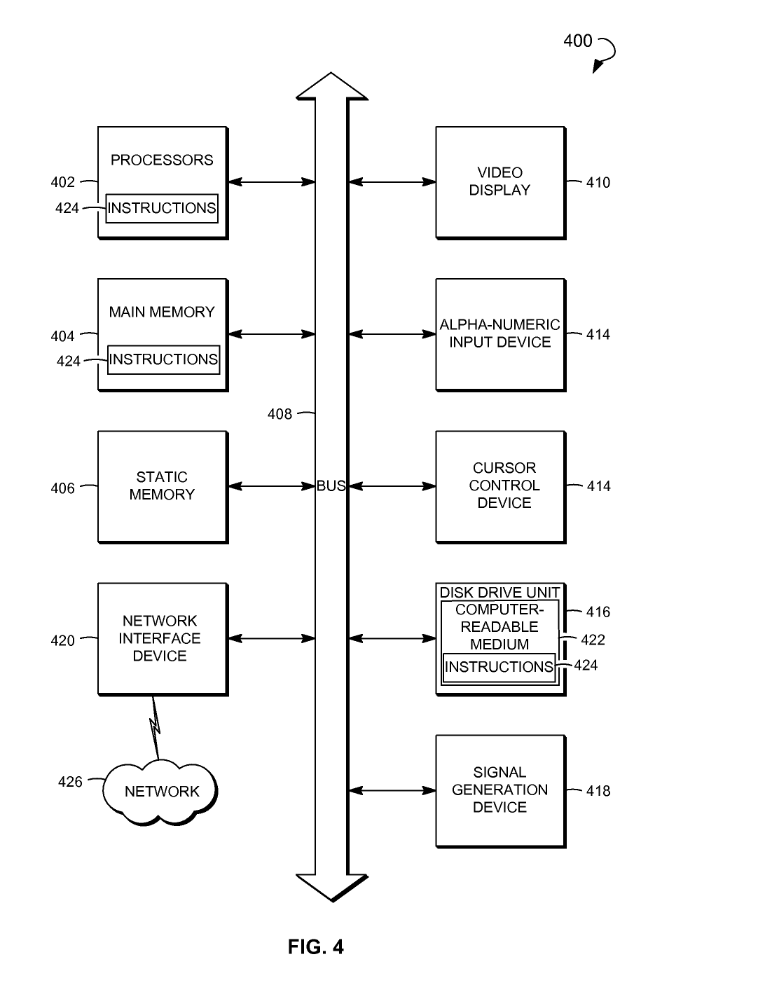

FIG. 4 shows a diagrammatic representation of a machine in the example electronic form of a computer system 400, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor or multiple processors 402 (e.g., a central processing unit (CPU), a graphics processing unit (GPU), or both), a main memory 404 and a static memory 406, which communicate with each other via a bus 408. The computer system 400 may further include a video display unit 410 (e.g., a liquid crystal display (LCD) or a cathode ray tube (CRT)). The computer system 400 may also include an alphanumeric input device 412 (e.g., a keyboard), a cursor control device 414 (e.g., a mouse), a disk drive unit 416, a signal generation device 418 (e.g., a speaker) and a network interface device 420.

The disk drive unit 416 includes a computer-readable medium 422, on which is stored one or more sets of instructions and data structures (e.g., instructions 424) embodying or utilized by any one or more of the methodologies or functions described herein. The instructions 424 may also reside, completely or at least partially, within the main memory 404 and/or within the processors 402 during execution thereof by the computer system 400. The main memory 404 and the processors 402 may also constitute machine-readable media.

The instructions 424 may further be transmitted or received over a network 426 via the network interface device 420 utilizing any one of a number of well-known transfer protocols (e.g., Hyper Text Transfer Protocol (HTTP)).

While the computer-readable medium 422 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The example embodiments described herein may be implemented in an operating environment comprising software installed on a computer, in hardware, or in a combination of software and hardware.

Thus, a system and method for selling a product via a social networking engine have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A method for selling a product via a social networking engine, the method comprising:
receiving, from a selling user, information associated with the product;
receiving, from the selling user, a request to publish a message associated with the product via the one or more social networking engines; and
publishing the message associated with the product in the one or more social networking engines.

2. The method of claim 1, wherein the message associated with the product is published in the one or more social networking engines on a social network page associated with the selling user.

3. The method of claim 1, wherein the product is content in the form of a text, photo, video, computer code, or combination thereof.

4. The method of claim 1, wherein the product is a physical article.

5. The method of claim 1, wherein the selling user is a user of a one or more social networking services.

6. The method of claim 1, wherein the selling user provides identification information to identify oneself.

7. The method of claim 1, further comprising:
receiving, from a user, a product selection information; and
redirecting the user to a purchasing interface for purchasing one or more product items based on the product selection information.

8. The method of claim 7, further comprising receiving a credit from the selling user after a sale of the product.

9. The method of claim 7, further comprising, prompting the user to provide feedback information after purchasing the product.

10. The method of claim 9, wherein the feedback information is used to rank the product.

11. A system for selling a product via a social networking engine, the system comprising:
a communication module to receive, from a selling user, information associated with the product, a request to publish a message associated with the product via the one or more social networking engines, a request, from a user of a social network, to select the product;
a publishing module to publish the message associated with the product via the one or more social networking engines;
a storing module to store the information associated with the product.

12. The system of claim 11, wherein the message associated with the product is published in the one or more social networking engines on a social networking service page associated with the selling user.

13. The system of claim 11, wherein the product is content in the form of a text, photo, video, computer code, or combination thereof.

14. The system of claim 11, wherein the product is a physical article.

15. The system of claim 11, wherein modules of the system are included in a social networking engine.

16. The system of claim 11, the system being coupled to the social networking engine.

17. The system of claim 11, further including a payment module configured to perform one or more of the following operations:
receive a payment information from the user; and
receive, for the selling user, a credit for the product;
receive, from the selling user, a credit for a sale of the product.

18. The system of claim 11, wherein, after receiving the payment information from a user, the user is prompted to provide feedback information.

19. A computer-readable medium comprising instructions, which when executed by one or more processors, perform the following operations:
receive, from a selling user, information associated with the product;
receive, from the selling user, a request to publish a message associated with the product via a one or more social networking engines; and
publish the message associated with the product via the one or more social networking engines.
